(19) United States
(12) Patent Application Publication
(10) Pub. No.: US 2011/0318467 A1
(43) Pub. Date: Dec. 29, 2011

(54) Hydroxypropyl Substituted Starches As Source of Soluble Fiber

(75) Inventors: Annette Evans, Decatur, IL (US); Daniel P. Berg, Madison, WI (US); Michelle P. Schwenk, Decatur, IL (US); Donald Harris, Springfield, IL (US); Judy Turner, Decatur, IL (US); Luke Xie, Decatur, IL (US)

(73) Assignee: Tate & Lyle Ingredients Americas, LLC, Decatur, IL (US)

(21) Appl. No.: 13/170,909

(22) Filed: Jun. 28, 2011

Related U.S. Application Data
(60) Provisional application No. 61/359,534, filed on Jun. 29, 2010.
(60) Provisional application No. 61/389,486, filed on Oct. 4, 2010.

(51) Int. Cl. A23L 1/0522; A23L 1/0562

(52) U.S. Cl. 426/576; 426/661

(57) ABSTRACT

The present invention relates to a food product with high levels of ethanol soluble fiber and total dietary fiber and methods of making the same. In particular, the food product contains at least one food ingredient and a modified high hydroxypropyl substituted starch. The modified starch is suitable as a non-animal derived gelatin replacement in foods traditionally prepared with gelatin and may also be used in extruded food products.

### CROSS REFERENCE TO RELATED APPLICATIONS

This application claims priority to U.S. Provisional Application No. 61/359,534, filed Jun. 29, 2010, and U.S. Provisional Application No. 61/389,486, filed Oct. 4, 2010, both of which are incorporated herein by reference in their entireties.

### BACKGROUND

The present invention relates to the use of modified starches to increase dietary fiber in food products. In particular, it has been found that starches with high levels of hydroxypropyl (HP) substitution contain high levels of ethanol soluble fiber and that highly hydroxypropyl substituted starches can be used to increase the content of ethanol soluble fiber which is a component of soluble fiber and total dietary fiber in food products. Further, it has been found that these starches can be used to enhance the fiber content of extruded food with little or no loss of initial fiber.

Consumption of dietary fiber has been associated with numerous health benefits. For example, studies have suggested that diets rich in dietary fiber can reduce the risk of cardiovascular disease, cancer, gastrointestinal problems, and obesity. See Campos et al., Nutr Hosp. 2005 January-February;20(1):18-25 (suggesting a link between the occurrence of colorectal cancer and low fiber diet); Kendall et al., Curr Atheroscler Rep. 2004 November;6(6):492-8 (suggesting that a diet rich in fiber can reduce LDL cholesterol); Kendall et al., J AOAC Int. 2004 May-June;87(3):769-74 (suggesting that a diet high in fiber can reduce the risk of chronic disease); Cernea et al., Acta Diabetol. 2003 40 suppl 2:S389-400 (suggesting that a diet high in fiber can reduce the risk of cardiovascular disease). Consumption of soluble fiber, a component of the total dietary fiber in a food, has also been associated with health benefits. These reported benefits are possibly related to the viscosity that many of these fibers possess. Highly soluble fibers—those soluble in ethanol—have been developed more recently and have also been shown to possess many health benefits.

Although it is desirable to increase the amount of fiber in foods, attempts at simply adding more fiber have been hindered because the addition of fiber frequently alters the taste and texture of food. Modified starches containing fiber are widely used in the food industry because of their texture attributes. However, the amount of modified starch that can be used in a food is also limited by the viscosity the starch may develop in the food. This has limited the amount of fiber that can be included in food products using modified starches.

In addition, it has also long been desirable to discover a vegetable based gelling agent that can be used as a replacement for gelatin, which is prepared from animals. Gelled starches, however, do not typically possess clear and elastic properties suitable for gelatin replacement in food products.

Extrusion processing of food products involves high shear, temperature, and pressure. Extrusion and other processing methods involving harsh conditions limit the type of fiber ingredients that can be used without significant loss of dietary fiber during processing.

It has been discovered that starches modified by high levels of hydroxypropyl substitution have high amounts of ethanol soluble fiber and can be used in the preparation of food products with high levels of soluble and dietary fiber. It has also been discovered that thinned, high hydroxypropyl substituted starches can be suitably used in food products in place of gelatin. Further, it has been discovered that starches modified by high levels of hydroxypropyl substitution may be used in extruded food products because they retain their ethanol soluble fiber content even under harsh processing conditions.

### SUMMARY OF THE INVENTION

The present invention provides for a food product made with a modified starch and at least one other food ingredient. The modified starch is one that is at least modified by hydroxypropyl substitution. The amount of hydroxypropyl substitution of the modified starch is at least about 8%. It has been discovered that modified starches with high levels of hydroxypropyl substitution contain high levels of ethanol soluble starches. Thus, the food product made with the hydroxypropyl substituted starch with at least about 8% hydroxypropyl substitution comprises at least about 2.5% ethanol soluble fiber.

In certain embodiments, the hydroxypropyl substituted starch is modified by hydroxypropyl substitution in alcohol. For example, a representative example of a method of modifying starch by hydroxypropyl substitution in alcohol comprises reacting starch with propylene oxide in a liquid medium comprised of a C₁-C₃ alkanol and water under alkaline conditions at reaction temperatures in excess of about 100° C.

The present invention also provides for a method of preparing a food product with a high total dietary fiber content. This method comprises incorporating a hydroxypropyl substituted starch, comprising at least 8% hydroxypropyl substitution, with at least one other food ingredient to prepare a food product comprising at least about 2.5% ethanol soluble fiber.

In certain embodiments of the method, the hydroxypropyl substituted starch is modified by hydroxypropyl substitution in alcohol. For example, a representative example of a method of modifying starch by hydroxypropyl substitution in alcohol comprises reacting starch with propylene oxide in a liquid medium comprised of a C₁-C₃ alkanol and water under alkaline conditions at reaction temperatures in excess of about 100° C.

The present invention also provides for a food product comprising a food ingredient and a thinned hydroxypropyl substituted starch. The amount of hydroxypropyl substitution of the thinned starch is at least about 8%. The food product made with the thinned hydroxypropyl substituted starch comprises at least about 2.5% ethanol soluble fiber.

In certain embodiments, the thinned hydroxypropyl substituted starch is modified by hydroxypropyl substitution in alcohol. For example, a representative example of a method of modifying starch by hydroxypropyl substitution in alcohol comprises reacting starch with propylene oxide in a liquid medium comprised of a C₁-C₃ alkanol and water under alkaline conditions at reaction temperatures in excess of about 100° C.

The present invention also provides for a method of preparing a food product with a high total dietary fiber content. This method comprises incorporating a thinned hydroxypropyl substituted starch, comprising at least 8% hydroxypropyl substitution, with at least one other food ingredient to prepare a food product comprising at least about 2.5% ethanol soluble fiber.

In certain embodiments of the method, the thinned hydroxypropyl substituted starch is modified by hydroxypropyl substitution in alcohol. For example, a representative example of a method of modifying starch by hydroxypropyl substitution in alcohol comprises reacting starch with propylene oxide in a liquid medium comprised of a C₁-C₃ alkanol and water under alkaline conditions at reaction temperatures in excess of about 100° C.

It has been discovered that thinned hydroxypropyl substituted starches can impart an elastic quality to food products similar to the qualities of gelatin. In certain embodiments, the food product is a food product traditionally prepared with gelatin. Representative examples of food products traditionally prepared with gelatin include marshmallows, gummy confections, gelatin desserts, and pie fillings.

It has also been discovered that the hydroxypropyl substituted starches of the invention are well suited for use in extruded food products because they retain their ethanol soluble fiber under the harsh conditions of extrusion. In certain embodiments, a food product is an extruded food product comprising a hydroxypropyl substituted starch. Certain embodiments are drawn to methods of preparing extruded food products comprising hydroxypropyl substituted starches.

### DETAILED DESCRIPTION

### I. Definitions

As used herein, an “ethanol soluble fiber” is a “highly soluble fiber.” Ethanol soluble fiber is also known to those of skill in the art as “resistant maltodextrin (RM)” and is also known as “resistant oligosaccharides (ROs).” For the purposes of this disclosure, “highly soluble fiber,” “ethanol soluble fiber,” “resistant maltodextrin,” and “resistant oligosaccharides” have the same meaning and are used interchangeably.

As used herein, the amount of “total dietary fiber (TDF)” in a food product refers to the amount of insoluble fiber and soluble fiber. TDF can be measured, for example, by AOAC 2001.03 or AOAC 2009.01. AOAC 2001.03 measures both the insoluble fiber component and soluble fiber component of TDF. For the purposes of this disclosure, TDF is measured by AOAC 2001.03 unless otherwise specified.

As used herein, the amount of “soluble fiber” in a food product refers to the amount of water soluble fiber and ethanol soluble fiber.

As used herein, a “high” or “highly” hydroxypropyl substituted starch is one with a substitution of at least about 8%.

As used herein, a food product with a “high dietary fiber content” is one with at least about 2.5% total dietary fiber as measured by AOAC 2001.03.

Concentrations, amounts, and other numerical data may be presented here in a range format (e.g., from 8% and 12%). It is to be understood that such range format is used merely for convenience and brevity and should be interpreted flexibly to include not only the numerical values explicitly recited as the limits of the range, but also to include all the individual numerical values or sub-ranges encompassed within that range, as if each numerical value and sub-range is explicitly recited. For example, a range of from 8% to 12% should be interpreted to include numerical values such as, but not limited to 8%, 8.5%, 9.7%, 10.3%, 12%, etc., and sub-ranges such as, but not limited to 8% to 11%, 9% to 10%, 9.9% to 11.9%, etc.

### II. Overview

Hydroxypropyl substitution has been used to prevent retrogradation of starch. Through analysis of several alcohol processed hydroxypropyl substituted starches, the inventors discovered that they contain a significant amount (between about 30% and about 55%) of ethanol soluble fiber. The present invention is based on Applicants' discovery that increasing the amount of hydroxypropyl substitution of starch leads to increased levels of ethanol soluble fiber. This was surprising because although it was known that crosslinking starch leads to increased resistant oligosaccharides and dietary fiber, a correlation between hydroxypropyl substitution and ethanol soluble fiber was not previously known.

### III. Food Product Comprising Highly Substituted HP Starch

Because of the demonstrated health benefits of a high fiber diet, it is desirable to incorporate dietary fiber into a wide range of food products. For example, food products with amounts of at least 2.5 g/serving are considered to be a good source of fiber and food products with amounts of at least 5 g/serving are considered to be an excellent source of fiber. One of skill in the art will recognize that while there are certain food products that are commonly marketed as having high fiber, many food products may benefit from additional fiber content and that the food products of the present invention are not limited to only those food products that have traditionally been high in fiber. The amount of fiber that could be added to food products has generally been limited by the negative impact on texture, taste, and viscosity of high levels of fiber. One aspect of the present invention is a food product with high fiber comprising a food ingredient and a highly hydroxypropyl substituted starch. Starches can be hydroxypropyl substituted by a number of methods, representative methods of which are identified in U.S. Pat. No. 4,452,978, which is incorporated herein in its entirety. (In the event that any part of the disclosure of U.S. Pat. No. 4,452,978 is inconsistent with the current disclosure, it is understood that the current disclosure is controlling). In particular, it has been discovered that high levels of hydroxypropyl substitution can be achieved by alcohol substitution. Therefore, in certain embodiments, the highly hydroxypropyl substituted starch is prepared by substitution in alcohol.

In certain embodiments of the present invention, the inclusion of a highly hydroxypropyl substituted starch (i.e., substitution of at least about 8%) produces a food product comprising at least about 2.5% of ethanol soluble fiber. In certain embodiments, the inclusion of a highly hydroxypropyl substituted starch produces a food product comprising at least about 3%, or at least about 4%, or at least about 5%, or at least about 6%, or at least about 7%, or at least about 8%, or at least about 9%, or at least about 10%, or at least about 20%, or at least about 30%, or at least about 40%, of ethanol soluble fiber. Because total dietary fiber (TDF) is composed of soluble fiber and insoluble fiber, and the soluble fiber component is composed of water soluble fiber and ethanol soluble fiber, a food product with at least about 2.5% of ethanol soluble fiber will also contain at least about 2.5% TDF. Thus, in certain embodiments of the present invention, the inclusion of a highly hydroxypropyl substituted starch produces a food product comprising at least about 2.5%, or at least about 3%, or at least about 4%, or at least about 5%, or at least about 6%, or at least about 7%, or at least about 8%, or at least about 9%, or at least about 10%, or at least about 20%, or at least about 30%, or at least about 40%, of total dietary fiber. The amount of ethanol soluble fiber that can be included is limited in part by the viscosity of the fiber in a food product. Hydration of a hydroxypropyl substituted starch increases its viscosity. Therefore, the amount of water in a food system that is available to the hydroxypropyl substituted starch will help determine the upper limit of hydroxypropyl substituted starch, and thus the upper limit of ethanol soluble fiber, than can be incorporated in a food product. It has been found that, in a dry mix of a food product, the amount of ethanol soluble fiber can be at least about 50%. Thus, in certain embodiments of the present invention, the inclusion of a highly hydroxypropyl substituted starch produces a food product comprising at least about 50% of ethanol soluble fiber and at least about 50% of total dietary fiber.

In certain embodiments of the present invention, the inclusion of a highly hydroxypropyl substituted starch produces a food product comprising from about 2.5% to about 50%, or from about 2.5% to about 40%, or from about 2.5% to about 30%, or from about 2.5% to about 20%, or from about 2.5% to about 10%, or from about 2.5% to about 9%, or from about 2.5% to about 8%, or from about 2.5% to about 7%, or from about 2.5% to about 6%, or from about 2.5% to about 5%, or from about 2.5% to about 4%, or from about 2.5% to about 3%, of ethanol soluble fiber. In certain embodiments of the present invention, the inclusion of a highly hydroxypropyl substituted starch produces a food product comprising from about 3% to about 50%, or from about 3% to about 40%, or from about 3% to about 30%, or from about 3% to about 20%, or from about 3% to about 10%, or from about 3% to about 9%, or from about 3% to about 8%, or from about 3% to about 7%, or from about 3% to about 6%, or from about 3% to about 5%, or from about 3% to about 4%, of ethanol soluble fiber. In certain embodiments of the present invention, the inclusion of a highly hydroxypropyl substituted starch produces a food product comprising from about 4% to about 50%, or from about 4% to about 40%, or from about 4% to about 30%, or from about 4% to about 20%, or from about 4% to about 10%, or from about 4% to about 9%, or from about 4% to about 8%, or from about 4% to about 7%, or from about 4% to about 6%, or from about 4% to about 5%, of ethanol soluble fiber. In certain embodiments of the present invention, the inclusion of a highly hydroxypropyl substituted starch produces a food product comprising from about 5% to about 50%, or from about 5% to about 40%, or from about 5% to about 30%, or from about 5% to about 20%, or from about 5% to about 10%, or from about 5% to about 9%, or from about 5% to about 8%, or from about 5% to about 7%, or from about 5% to about 6%, of ethanol soluble fiber. In certain embodiments of the present invention, the inclusion of a highly hydroxypropyl substituted starch produces a food product comprising from about 6% to about 50%, or from about 6% to about 40%, or from about 6% to about 30%, or from about 6% to about 20%, or from about 6% to about 10%, or from about 6% to about 9%, or from about 6% to about 8%, or from about 6% to about 7%, of ethanol soluble fiber. In certain embodiments of the present invention, the inclusion of a highly hydroxypropyl substituted starch produces a food product comprising from about 7% to about 50%, or from about 7% to about 40%, or from about 7% to about 30%, or from about 7% to about 20%, or from about 7% to about 10%, or from about 7% to about 9%, or from about 7% to about 8%, of ethanol soluble fiber. In certain embodiments of the present invention, the inclusion of a highly hydroxypropyl substituted starch produces a food product comprising from about 8% to about 50%, or from about 8% to about 40%, or from about 8% to about 30%, or from about 8% to about 20%, or from about 8% to about 10%, or from about 8% to about 9%, of ethanol soluble fiber. In certain embodiments of the present invention, the inclusion of a highly hydroxypropyl substituted starch produces a food product comprising from about 9% to about 50%, or from about 9% to about 40%, or from about 9% to about 30%, or from about 9% to about 20%, or from about 9% to about 10%, of ethanol soluble fiber. In certain embodiments of the present invention, the inclusion of a highly hydroxypropyl substituted starch produces a food product comprising from about 10% to about 50%, or from about 10% to about 40%, or from about 10% to about 30%, or from about 10% to about 20%, of ethanol soluble fiber. In certain embodiments of the present invention, the inclusion of a highly hydroxypropyl substituted starch produces a food product comprising from about 20% to about 50%, or from about 20% to about 40%, or from about 20% to about 30%, of ethanol soluble fiber. In certain embodiments of the present invention, the inclusion of a highly hydroxypropyl substituted starch produces a food product comprising from about 30% to about 50% or from about 30% to about 40%, of ethanol soluble fiber. In certain embodiments of the present invention, the inclusion of a highly hydroxypropyl substituted starch produces a food product comprising from about 40% to about 50% of ethanol soluble fiber.

### IV. Highly Hydroxypropyl Substituted Starches

One aspect of the present invention is a highly hydroxypropyl substituted starch. One of skill in the art will recognize that numerous types of starches can be used as a starting material for hydroxypropyl substitution. The particular starch chosen will depend on its performance, availability, cost, and the food product.

The starch used in preparing the present invention may be any starch derived from any native source. A native starch as used herein, is one as it is found in nature. Also suitable are starches derived from a plant obtained by standard breeding techniques including crossbreeding, translocation, inversion, transformation, insertion, irradiation, chemical or other induced mutation, or any other method of gene or chromosome engineering to include variations thereof. In addition, starch derived from a plant grown from induced mutations and variations of the above generic composition which may be produced by known standard methods of mutation breeding are also suitable.

Starches can be described by source such as from cereals, tubers and roots, legumes, and fruits. Typical sources or starch include, but are not limited to corn, potato, sweet potato, wheat, tapioca, pea, banana, plantain, barley, oat, rye, triticale, sago, amaranth, arrowroot, canna, sorghum, and rice, as well as low amylose (waxy) and high amylose varieties thereof.

Starches may also be defined by certain properties. For example, a starch may be an “amylosic” or high amylose starch comprising substantially pure amylose, a high amylopectin starch, or natural or artificial mixtures of amylose and amylopectin (such as those containing at least 50% of amylose by weight). Starches may also comprise substantially less amylose, such as a non-waxy amylose-containing starch generally comprising about 25-30% amylose by weight.

One of skill in the art will also recognize that commercial starches often comprise some level of contamination with other starches. For example, commercial waxy corn starch can contain several percent dent corn starch contamination. For example, a commercial waxy corn starch may comprise less than about 10% or less than about 7% dent starch due to contamination. The starch material may also be any other genetic variety of starch—such as ae or dull—known to one of skill in the art or of other starch types as described herein including those that are natural, genetically altered, or obtained from hybrid breeding. The starch material may also be a combination of different starches.

Starches may be modified by a variety of methods. Representative, non-limiting examples of chemically modified starches are hydroxypropylated starches, starch adipates, acetylated starches, phosphorylated starches, crosslinked starches, acetylated and organically esterified starches, phosphorylated and inorganically esterified starches, cationic, anionic, nonionic, and zwitterionic starches, and succinate and substituted succinate derivatives of starch. Such modifications are known in the art, for example in Modified Starches: Properties and Uses, Ed. Wurzburg, CRC Press, Inc., Florida (1986). Other suitable modifications and methods are disclosed in U.S. Pat. Nos. 4,626,288, 2,613,206 and 2,661,349. In certain embodiments, the modified starches are thermally converted, fluidity or thin boiling type products derived from the aforementioned types of chemically modified starches.

Hydroxypropyl substituted (HP) starches are useful in the preparation and compositions of food products. The amount of substitution can vary, for example, as a result of the process used to achieve substitution. The hydroxypropyl substituted starches of the present invention are highly substituted, meaning the amount of substitution is at least about 8%. In certain embodiments, the amount of HP substitution is at least about 9%. In certain embodiments, the amount of HP substitution is at least about 10%. In certain embodiments, the amount of HP substitution is at least about 11%. In certain embodiments, the amount of HP substitution is at least about 12%. In certain embodiments, the amount of HP substitution is at least about 12.5%. In certain embodiments, the amount of HP substitution is at least about 15%. In certain embodiments, the amount of HP substitution can at least about 25%. In certain embodiments, the amount of HP substitution is from about 8% to about 25%, or from about 8% to about 15%, or from about 8% to about 12.5%, or from about 8% to about 12%, or from about 8% to about 11%, or from about 8% to about 10%, or from about 8% to about 9%. In certain embodiments, the amount of HP substitution of a modified starch is from about 9% to about 25%, or from about 9% to about 15%, or from about 9% to about 12.5%, or from about 9% to about 12%, or from about 9% to about 11%, or from about 9% to about 10%. In certain embodiments, the amount of HP substitution of a modified starch is from about 10% to about 25%, or from about 10% to about 15%, or from about 10% to about 15%, or from about 10% to about 12.5%, or from about 10% to 12%, or from about 10% to about 11%. In certain embodiments, the amount of HP substitution of a modified starch is from about 11% to about 25%, or from about 11% to about 15%, or from about 11% to about 12.5%, or from about 11% to about 12%. In certain embodiments, the amount of HP substitution of a modified starch is from about 12% to about 25%, or from about 12% to about 15%, or from about 12% to about 12.5%. In certain embodiments, the amount of HP substitution of a modified starch is from about 12.5% to about 25% or from about 12.5% to about 15%. In certain embodiments, the amount of HP substitution of a modified starch is from about 15% to about 25%.

In certain embodiments, the highly hydroxypropyl substituted starch may be further modified by methods as previously described or by techniques such as oxidation and bleaching. A bleached starch is a starch which has been treated with low levels of oxidant to improve whiteness. An oxidized starch is a starch which has been modified by treatment with one or more oxidizing agents such as sodium hypochlorite.

In certain embodiments, the highly hydroxypropyl substituted starch is crosslinked. The crosslinking is conducted using methods widely known in the art, representative methods of which are described, for example, in Modified Starches: Properties and Uses, Ed. Wurzburg, CRC Press, Inc., Florida (1986). The amount of modification may be varied to get the desired properties and total dietary fiber content.

Starches can be chemically cross-linked using a variety of cross-linking agents. However, the Food and Drug Administration regulates compositions and concentrations of chemicals used in food production. See 21 CFR §172.892(d), which limits either the reagent concentration during production or the phosphorous content of the finished product, as follows:

Phosphorus oxychloride (not to exceed 0.1% in reaction mix);

Sodium trimetaphosphate (residual phosphate not to exceed 0.04%, calculated as phosphorous);

Sodium trimetaphosphate and sodium tripolyphosphate (residual phosphate not to exceed 0.4%, calculated as phosphorous).

Thus, in certain embodiments, cross-linking agents are those selected from the group consisting of sodium trimetaphosphate (STMP), sodium tripolyphosphate (STPP), phosphoryl chloride, and mixtures thereof. One skilled in the art would appreciate that other cross-linking agents may be used with similar effect, and may be unregulated outside of the United States. For example, adipic acid and epichlorohydrin may be used.

Table 1 shows a comparison between the amount of hydroxypropyl substitution that was measured in different starch sources and the resulting amount of resistant maltodextrin (RM) (i.e., ethanol soluble fiber) and amount of TDF. Starches A, B, C, and D represent hydroxypropyl substituted starches that were produced with varying levels of hydroxypropyl substitution.

TABLE 1
Comparison of HP Substitution and Measured RM and TDF.

| | % HP | | Total Dietary |
|---|---|---|---|
| | substitution | % RM | Fiber % |
| Waxy | 0% | 0.90% | 1.20% |
| A | 5% | 30.50% | 32.30% |
| B | 6.66% | 37.50% | 38.90% |
| C | 9.56% | 54.40% | 57.30% |
| D | 12.46% | 79% | |

A. Alcohol Substitution

It has been discovered that modified starches produced by methods of hydroxypropyl substitution in alcohol can be highly substituted and thus contain high amounts ethanol soluble fiber. For example, levels of at least 25% substitution have been achieved. U.S. Pat. No. 4,452,978 discloses methods of preparing hydroxypropyl substituted starch by reacting starch with propylene oxide in a liquid medium comprised of a C1-C3 alkanol and water under alkaline conditions at reaction temperatures in excess of about 100° C., and with reaction times ranging from less than about 1 minute to about 1 hour. Thus, in certain embodiments, a hydroxypropyl substituted starch is substituted in alcohol by reacting starch with propylene oxide in a liquid medium comprised of a C₁-C₃ alkanol and water under alkaline conditions at reaction temperatures in excess of about 100° C. In certain embodiments, the reaction times ranges from less than about 1 minute to about 1 hour.

In certain embodiments, the first step for preparing the modified starch is the preparation of a reaction slurry containing the starch starting material, an alkaline agent, and propylene oxide in a liquid medium comprising a C₁-C₃ alkanol and water, preferably less than 10% water by weight of the medium including the water in the starch. The reaction slurry is heated to a temperature of about 145° C. to about 175° C., under autogenic pressure for a period of time ranging from about 1 minute to about 1 hour. The heating process can be conducted in a sealed vessel (batch process) or by passing the reaction slurry through a heated confined zone at a rate calculated to give the required residence time for the slurry in the heated zone (continuous or semicontinuous process).

In certain embodiments of alcohol substitution, the reaction slurring is prepared by (1) suspending the starch starting material in about 1 to about 3 parts by weight C₁-C₃ alcohol; (2) optionally sparging the alcoholic starch slurry with nitrogen to remove or minimize the amount of dissolve oxygen in the slurry; (3) adding an alkali metal hydroxide (preferably sodium hydroxide or potassium hydroxide or an equivalent thereof) either as pellets or flakes or in concentrated aqueous or alcoholic solution; and (4) adding propylene oxide in an amount sufficient to give the desired hydroxypropyl substitution levels in the starch product.

The alcohol which serves as the major component of the reaction slurry can be methanol, ethanol, propanol, or isopropanol. In certain embodiments, ethanol is preferred. Some proportion of water is also desirable in the reaction slurry. The amount of water in the slurry, however, must be below that which would cause gelatinization of the hydroxypropylated product starch under the reaction conditions of the process. The maximum amount of water which should be added to the reaction mixture depends primarily on the substitution level of the hydroxypropylated starch product, the temperature at which hydroxypropylation reaction is conducted, the moisture level of the starch starting material, the form in which the alkaline catalyst is added (that is pellets or flakes opposed to concentrated aqueous solution) and to some extent the alcohol used as the processing medium. Generally where the hydroxypropylated starch product will have a level of substitution such that the product will have a pasting temperature below about 60° C., the reaction slurry should contain less than about 10% by weight water including the water in the starch. Where the granular starch starting material has a water content between about 8 and about 12% by weight, and where the alkaline reagent is added as an aqueous solution, additional water need not be added to the reaction slurry. Applicant has found that the present process is most efficient at the preferred reaction temperatures where the total water content, including the water in the ungelatinized starch starting material, is within a range of about 2 to about 5% by weight of the slurry. A water content of less than about 5% by weight of the slurry is particularly preferred, too, where the starch starting material contains phosphate ester cross-linkages which are more labile under the process conditions at the higher water levels.

The reaction slurry is rendered alkaline by the addition of an alkaline reagent which is substantially soluble in the liquid phase of the reaction slurry. Representative alkaline reagents include alkali metal hydroxides, especially sodium hydroxide or potassium hydroxide or equivalents thereof. As mentioned above the alkaline reagent can be added as a solid, such as pellets or flakes, or in concentrated aqueous or alcoholic solution. In certain embodiments, from about 1 to about 3% by weight of the starch (dsb) of the alkaline reagent is added to the reaction slurry. When sodium or potassium hydroxide is used as the alkaline reagent, applicant has found that the present hydroxypropylation reaction is most efficient when the alkali metal hydroxide is added in an amount equal to about 1.5 to about 2.5% of the weight of starch, dsb. In certain embodiments of the hydroxypropylation process, an alkali metal hydroxide is utilized in the reaction slurry at a rate of about 1.8% of weight of the starch, dsb.

In certain embodiments of alcohol substitution, the hydroxypropylating agent is propylene oxide. The amount of propylene oxide used to carry out this process depends primarily on the desired level of hydroxypropylation of the product reduced-pasting-temperature starch and, as the skilled practitioner will recognize, the efficiency of the hydroxypropylation process under the present conditions.

The reaction of the present hydroxypropylation process, that is the ratio of hydroxypropyl in the starch product to that added to the reaction slurry as propylene oxide depends to some degree on the specific reaction conditions employed, especially time, temperature, water content of the slurry, and degree of alkalinity. Under certain conditions hydroxypropylation proceeds at efficiencies ranging from about 40 to about 70% The amount of propylene oxide needed to effect the desired level of hydroxypropylation of the starch starting material can be estimated using the 40 to 70% efficiency figures and thereafter adjusted in accordance with actual efficiencies measured under the specific conditions used for the hydroxypropylation process.

The alcohol substitution process can be conducted at reaction temperatures ranging from about 100° C. to about 180° C. (or about 210° F. to about 360° F.) and preferably at temperatures between about 145° C. and 175° C. (about 290° C. to about 350° F.). Because the reaction temperatures are far in excess of the boiling point of the liquid medium, the process must be conducted in a closed vessel or otherwise under pressure sufficient to keep the medium in the liquid state at the reaction temperatures.

The time required to complete the present process depends on process parameters such as the reaction temperature, starch concentration, time, the amount of propylene oxide in the reaction mixture, and the desired level of hydroxypropylation of the reduced-pasting-temperature-granular starch product. The reaction time can range anywhere from less than 1 minute up to about 1 hour. In certain embodiments within a temperature range of about 145° C. to about 175° C., reaction time can range from under 5 minutes to about 30 minutes.

While the starch products can be left in the alkaline state, in certain embodiments, they are neutralized with acid. After the heating step the starch slurry is usually cooled to below about 150° F., and then treated with a neutralizing amount of an acid, for example, glacial acetic acid. Enough acid should be added to the reaction mixture so that a 50-ml aliquot of the slurry in a 150-ml of distilled water at room temperature will have a pH of about 4.5-5. Because diffusion of alkali from the processed starch granules into the alcohol medium is slow, the reaction slurry is typically stirred following addition of the acid for a period of about 15 minutes to about 60 minutes. The time required to complete the starch neutralization process can be minimized by warming the neutralizing reaction medium.

The reduced-pasting-temperature granular starch product is separated from the liquid medium component of the reaction slurry by filtration or centrifugation, washed with one or more volumes of the alcohol used in the process (or a mixture of that alcohol and water) and then dried or desolventized by conventional methods. In certain embodiments, the starch is dried in an oven to a certain volatiles level and then contacted with a hot humid gas, preferably moist air, while the starch is maintained at a temperature from about 140° F. to about 250° F.

It has been discovered that by using this process, hydroxypropyl substitution levels of greater than about 8%, and at least about 25%, can be achieved.

### B. Thinned Starches

In certain embodiments, the modified high HP starch may be further modified by thinning the composition to reduce its viscosity. For example, the molecular weight of the starch material may be reduced by acid thinning, enzyme thinning, oxidation, thermal degradation, mechanical degradation, or a high shear heating process (i.e., jet cooking). In particular, starches may be thinned using heat and/or acid or a high shear heating process (i.e., jet cooking). Thinned starches are especially useful in applications where viscosity development of the starch is not desired. For example, for use in high fiber beverage applications.

Because of their reduced viscosity, thinned highly hydroxypropyl substituted starches allow for higher inclusion levels in the same types of foods than starches that have not been thinned. Therefore, hydroxypropyl substituted starches that have been thinned by any degree may be used in food products to increase the amount of ethanol soluble fiber.

It has also been discovered that thinned highly hydroxypropyl substituted starches that have been thinned to achieve a significant reduction in viscosity have properties that make them especially suitable for use in food products typically containing gelatin as a direct replacement of gelatin. Representative examples of food products traditionally prepared with gelatin include, but are not limited to, marshmallows, gelled desserts, creme filling, and gummy confections. People have been searching for a vegetable based gelling agent like gelatin for a long time. Without being bound by theory, it is believed that the hydroxypropyl level on the starch when it gels is what provides an elastic, clear gel quality comparable to gelatin. This quality is closer to the characteristics of a gelatin gel than achievable with typical starches. In certain embodiments, the replacement level is between 1 to 3 times as much thinned high hydroxypropyl substituted starch as gelatin. One of skill in the art will recognize that the amount of thinning, or reduction in viscosity, will depend upon the desire application.

In certain embodiments, a thinned highly hydroxypropyl substituted starch can be used in combination with another starch in a food product. For example, addition of an unmodified gelling starch adds to the speed of gelation and gives more structure to the warm gel (before aging). Another example would be the combination of an emulsifier to match the emulsifying properties of gelatin.

### V. Preparation of Food Products Comprising High HP Starch

Another aspect of the present invention relates to methods of preparing food products comprising highly hydroxypropyl substituted starch and methods of preparing food products comprising thinned highly hydroxypropyl substituted starch. Numerous specific representative examples of methods for preparing of food products comprising highly hydroxypropyl substituted starch and thinned highly hydroxypropyl substituted starch are provided herein. In certain embodiments, a food product with a high ethanol soluble fiber content is prepared by incorporating a highly hydroxypropyl substituted starch. In certain embodiments, the highly hydroxypropyl substituted starch is produced by alcohol substitution. In certain embodiments, the highly hydroxypropyl substituted starch is modified by hydroxypropyl substitution in alcohol by reacting starch with propylene oxide in a liquid medium comprised of a C₁-C₃ alkanol and water under alkaline conditions at reaction temperatures in excess of about 100° C. In certain embodiments, the hydroxypropyl substituted starch is a thinned hydroxypropyl substituted starch.

The food product also comprises at least one additional food ingredient. One of skill in the art will recognize that there are numerous ways to incorporate ingredients into food products from hand mixing to the use of industrial mixers. The order of incorporation of ingredients may be varied to best suit the type of equipment used and the type of food product being prepared. The time of incorporation may be from short to long and may require from gentle to vigorous incorporation. One of skill in the art will recognize that determining these and similar parameters are routine in the preparation of food products and that the present invention can be practiced by one of skill in the art in any such preparations.

### VI. Extruded Food Products

The highly hydroxypropyl substituted starches of the present invention can be classified as type 4 resistant starches (chemically modified resistant starch). It was discovered that these starches were highly stable in extrusion processing with respect to fiber retention. Total dietary fiber analysis showed that no dietary fiber was lost during extrusion (Example 11, Table 2). Therefore, the highly hydroxypropyl substituted starches of the present invention are suitable for use in extruded food products.

In certain embodiments, the highly hydroxypropyl substituted starch used in an extruded food product is also crosslinked. In certain embodiments, the highly hydroxypropyl substituted starch used in an extruded food product comprises from about 0% to about 4% crosslinking and from about 8% to about 12% hydroxypropyl substitution. In certain embodiments, the hydroxypropyl substituted starch used in an extruded food product comprises from about 0% to about 1%, from about 0% to about 2%, or from about 0% to about 3% crosslinking. In certain embodiments, the hydroxypropyl substituted starch used in an extruded food product comprises from about 1% to about 2%, from about 1% to about 3%, or from about 1% to about 4% crosslinking. In certain embodiments, the hydroxypropyl substituted starch used in an extruded food product comprises from about 2% to about 3% or from about 2% to about 4% crosslinking. In certain embodiments, the hydroxypropyl substituted starch used in an extruded food product comprises from about 3% to about 4% crosslinking. In certain embodiments, the hydroxypropyl substituted starch used in an extruded food product comprises about 0%, 0.5%, 1%, 1.5%, 2%, 2.5%, 3%, 3.5%, or about 4% crosslinking. In certain embodiments, the hydroxypropyl substituted starch used in an extruded food product comprises from about 8% to about 9%, from about 8% to about 10%, from about 8% to about 11%, or from about 8% to about 12% hydroxypropyl substitution. In certain embodiments, the hydroxypropyl substituted starch used in an extruded food product comprises from about 9% to about 10%, from about 9% to about 11%, or from about 9% to about 12% hydroxypropyl substitution. In certain embodiments, the hydroxypropyl substituted starch used in an extruded food product comprises from about 10% to about 11% or from about 10% to about 12% hydroxypropyl substitution. In certain embodiments, the hydroxypropyl substituted starch used in an extruded food product comprises from about 11% to about 12% hydroxypropyl substitution. In certain embodiments, the hydroxypropyl substituted starch used in an extruded food product comprises about 8%, 8.5%, 9%, 9.5%, 10%, 10.5%, 11%, 11.5%, or 12% hydroxypropyl substitution. In certain embodiments, the hydroxypropyl substituted starch used in an extruded food product is a waxy starch.

The highly hydroxypropyl substituted starch is added to any food formulation prior to processing in an amount able to provide for an extruded food product that comprises at least about 2.5% ethanol soluble fiber. Because of the high fiber retention of highly hydroxypropyl substituted starches, one of skill in the art will understand that in general, the amount of highly hydroxypropyl substituted starch needed to provide for an extruded food product comprising at least about 2.5% ethanol soluble fiber will be similar in amount to that needed to provide for the same percentage of ethanol soluble fiber without extrusion.

In certain embodiments, the amount of ethanol soluble fiber that is retained from the amount present in the pre-processed product compared to the amount present in the extruded product is at least about 90%. In certain embodiments, the amount of ethanol soluble fiber that is retained from the amount present in the pre-processed product compared to the amount present in the extruded product is at least about 95%. In certain embodiments, the amount of ethanol soluble fiber that is retained from the amount present in the pre-processed product compared to the amount present in the extruded product is at least about 98%. In certain embodiments, the amount of ethanol soluble fiber that is retained from the amount present in the pre-processed product compared to the amount present in the extruded product is at least about 99%. In certain embodiments, the amount of ethanol soluble fiber that is retained from the amount present in the pre-processed product compared to the amount present in the extruded product is at least about 100%. Extrusion of the food products may be conducted using any suitable equipment known in the art. The process parameters used can vary from less severe to severe. Numerous combinations of process parameters exist that have been used to describe the process parameter window of the extrusion. Representative process parameters include product moisture, screw design and speed, feed rate, barrel temperature, die design, formula and length/diameter (L/d) ratios, Specific Mechanical Energy (SME) and Product Temperature (PT). For example, in certain embodiments, the food product is exposed during extrusion to an SME of at least 130 Wh/kg and a PT of at least 60° C. In certain embodiments, the food product is exposed during extrusion to an SME of at least about 160 Wh/kg and a PT of at least 190° C. In another embodiment, the food product is exposed during extrusion to an SME of no greater than 500 and a PT of no greater than 220° C.

### Examples

The following disclosed embodiments are merely representative of the invention which may be embodied in various forms. Thus, specific structural, functional, and procedural details disclosed in the following examples are not to be interpreted as limiting.

### Example 1

### Bundt Cake

Ethanol soluble fiber is about 6.3%.

Total dietary fiber is about 6.3%.

| Ingredients | % |
|---|---|
| Flour | 24.63 |
| Sugar | 21.42 |
| Eggs, liquid whole | 14.65 |
| Water | 11.99 |
| High HP starch (~10% substitution) | 11.03 |
| Soybean Oil | 6.87 |
| Emulsified cake and icing shortening | 6.87 |
| Nonfat dry milk, high heat | 1.46 |
| Corn syrup solids | 0.54 |
| Salt | 0.19 |
| Flavor | 0.1 |
| Baking Soda | 0.09 |
| Emulsifier | 0.16 |
| Total | 100 |

Preparation:

1. Mix dry ingredients. Blend dry ingredients with shortening.

2. Add all liquids except soybean oil. Mix. Add soybean oil and mix.

3. Place in mini bundt cake pans. Bake at 160° C. for approximately 30 minutes.

### Example 2

### Chocolate Creme Pie Filling

Ethanol soluble fiber is about 2.3%.

Total dietary fiber is about 2.3%.

| Ingredients | % |
|---|---|
| Water | 60.39 |
| Sucrose | 12.08 |
| Fructose | 12.08 |
| Flavors | 3.39 |
| Maltodextrin | 3.02 |
| Nonfat dry milk, low heat | 2.66 |
| High HP starch (~10% substitution) | 4.5 |
| Alginate blend, Protanal BK 68542 | 0.85 |
| Soybean oil | 0.85 |
| Salt | 0.18 |
| Total | 100 |

Preparation:

1. Place sugars in a mixing bowl. Add oil while mixing on low speed.

2. Blend all other dry ingredients in a separate container. Add to the mixing bowl while mixing on low speed. Scrape sides of bowl and blend until combined.

3. With mixer on low setting, add cold water to the dry mix.

4. Mix for 3 minutes, scraping the sides of the bowl.

5. Pour into prepared pie crust and refrigerate or freeze.

### Example 3

### Berry Muffins

Ethanol soluble fiber is about 3.0%.

Total dietary fiber is about 3.0%.

| Ingredients | % |
|---|---|
| Water | 24.95 |
| Sugar | 21.11 |
| Flour | 25.98 |
| Cake and icing shortening | 10.4 |
| Berries, frozen | 7.41 |
| High HP starch (~10% substitution) | 5.23 |
| Egg whites, dry | 1.92 |
| Nonfat dry milk, high heat | 0.81 |
| Baking soda | 0.48 |
| Leavening | 0.5 |
| Salt | 0.3 |
| Sodium propionate | 0.27 |
| Flavor | 0.23 |
| Emulsifier | 0.41 |
| Total | 100 |

Dry Mix Preparation:

1. Premix salt and sugar. Place in a mixer and mix.

2. Add shortening. Mix.

3. Pre-blend remaining dry ingredients. Add dry ingredients to mixer and mix.

Muffin Batter Preparation.

1. Add water to dry mix and mix.

2. Add berries and mix.

3. Pour into paper lined muffin cups.

4. Bake until golden brown, about 14 minutes at 375° F. (117° C.).

### Example 4

### Pudding Mix

Ethanol soluble fiber is about 50% in dry mix.

Total dietary fiber is about 50% in dry mix.

| Ingredients | % |
|---|---|
| Thinned High HP starch (~10% | 89.089 |
| substitution) | |
| Tetrasodium pyrophosphate | 2.7 |
| Disodium phosphate | 2.7 |
| Emulsifier | 2.05 |
| Titanium dioxide | 1.3 |
| Flavor | 1.02 |
| Salt | 0.85 |
| Sucralose | 0.172 |
| Bakers egg shade | 0.08 |
| Acesulfame K | 0.039 |
| Total | 100 |

Preparation:

1. Mix dry ingredients.

2. To prepare pudding, mix 45 g pudding mix with 474 g cold milk and chill.

### Example 5

### Marshmallow

Example of thinned high HP starch used as a gelatin replacement.

Ethanol soluble fiber is about 3.5 g per 100 g in mix.

Total dietary fiber is about 3.5 g per 100 g in mix.

| Ingredients | % |
|---|---|
| SWEETOSE ® 4300 Corn Syrup | 34.6 |
| Titanium Dioxide | 0.01 |
| Sugar | 41.6 |
| Thinned high HP starch (~10% | 6.2 |
| substitution) | |
| Water | 17.5 |
| Total | 100 |

Preparation:

1. Weight the SWEETOSE® into a bowl and disperse the titanium dioxide. Preheat the mixture to 135° F. (57.2° C.).

2. Add the rest of the ingredients and heat to 200° F. (93° C.).

3. Cool mixture to 145° F. (62.8° C.).

4. Whip for 4 minutes (to about 0.5 density).

5. Deposit or extrude marshmallow into moulding starch and allow to set.

### Example 6

### “Gelatin” Dessert

Example of thinned high HP starch used as a gelatin replacement.

Ethanol soluble fiber is about 7.3 g in 100 g of product.

Total dietary fiber is about 7.3 g in 100 g of product.

| Ingredients | % |
|---|---|
| Sugar | 14.21 |
| Adipic acid | 0.14 |
| Fumaric acid | 0.1 |
| Strawberry flavor | 0.08 |
| Disodium phosphate | 0.03 |
| Color (red #40) | 0.02 |
| 15% solution thinned high HP | 85.42 |
| starch (~10% substitution) and | |
| water | |
| Total | 100 |

Preparation:

1. Mix measured amounts of dry ingredients.

2. Add to 15% solution of starch and water.

3. Dissolve dry ingredients completely.

4. Refrigerate, preferably for at least about 4 hours.

### Example 7

### “Gummy Confection”

Example of thinned high HP starch used as a gelatin replacement.

Ethanol soluble fiber is about 11 g in 100 g of product.

Total dietary fiber is about 11 g in 100 g of product.

| Ingredients | % |
|---|---|
| 80% Solids HFCS* | 80 |
| Thinned High HP Starch (~10% | 20 |
| substitution) | |
| Total | 100 |

*Make 80% Solids HFCS by mixing 80% ISOSWEET ® 5500 with 20% KRYSTAR ® 300.

Preparation:

1. Heat syrup to 200° F., then disperse thinned HP starch into the syrup.

2. Allow to de-aerate by placing mixture in a funnel for approximately 30 minutes.

3. Deposit mixture into desired moulds and heat at 300° F. for 30 minutes.

4. Allow to cool, then demould.

### Example 8

### Chocolate Crème Pie Filling

Example of thinned high HP starch used as a gelatin replacement.

Ethanol soluble fiber is about 7.4 g in 100 g of product.

Total dietary fiber is about 7.4 g in 100 g of product.

| Ingredients | % |
|---|---|
| Water | 52.71 |
| Thinned high HP starch (~10% | 13.12 |
| substitution) | |
| Sucrose | 12.08 |
| Krystar ® 300 - fructose | 12.08 |
| Dutched cocoa powder d-11-s | 3.21 |
| Nonfat dry milk, low heat | 2.66 |
| Mirathik ® 609 - modified starch | 2.08 |
| Alginate blend protanal bk 6854 | 0.85 |
| Soybean oil | 0.85 |
| Salt | 0.18 |
| vanilla creamy n*a flavor | 0.18 |
| Total | 100 |

Preparation:

1. Place sucrose and Krystar® in a mixing bowl. Add oil while mixing on low speed.

2. Blend all other dry ingredients in a separate container.

3. Add to the mixing bowl while mixing on low speed.

4. Scrape sides of bowl and blend until combined with mixer on low setting.

5. Add cold water to the dry mix.

6. Mix for 3 minutes, scraping the sides of the bowl.

7. Pour into prepared pie crust and refrigerate or freeze.

### Example 9

### Hydroxypropyl Substitution in Alcohol

The following is a representative method of preparing a hydroxypropyl substituted starch in alcohol. One of skill in the art will recognize that aspects of this specific example may be modified in various ways.

1. Weigh out 338 g dry solids (ds) of waxy #1 starch.

2. Add 3A ethanol to give a 31% starch slurry (938 mL).

3. Add 1.7% dry starch basis (dsb) sodium hydroxide using 50% solution.

4. Calculate amount of water needed to give a 9:1 ethanol/water mixture. Water from the starch and sodium hydroxide has to be taken into account in the calculation. Water from the 3A ethanol is not taken into account.

5. Transfer slurry to pressure rated steel reactors and record exact weight of sample added to reactors.

6. Add 17% dsb propylene oxide to the starch slurry.

7. Set temperature to 149° C.; reaction time is 40 minutes once the desired temperature has been reached.

8. Cool reactor to below 40° C. and neutralize the slurry to pH ˜5 using phosphoric acid.

9. Remove slurry from reactors and check pH; add additional phosphoric acid if needed.

10. Filter the slurry and wash 3 times with 3A ethanol.

11. Dry overnight at 50° C. in a convection oven.

12. Grind and label.

### Example 10

### Thinning of Highly Hydroxypropyl Substituted Starch

### A) Heat

11.9% (db) high HP starch was slowly dispersed in warm deionized water. The sample was heated at 120° C. with stirring at 50 rpm for about 24 hours. The sample was then removed and stored in the refrigerator until further use.

### B) Heat and Spray-Drying

11.9% (db) high HP starch was slowly dispersed in warm deionized water. The sample was heated at 120° C. with stirring at 50 rpm for about 24 hours. The sample was then removed and spray dried using a lab scale spray dryer.

### C) Heat and Low pH

20% (db) high HP starch was slowly dispersed in water at pH 2. The sample was heated at 120° C. with stirring at 50 rpm for about 3 hours. The sample was then neutralized using 5% NaOH and stored in the refrigerator until further use.

### D) Jet Cooking

1.8% (db) high HP starch was jet cooked using a laboratory scale jet cooker with 45 lbs back pressure and 280° F. (140° C.). Residence time in the jet cooker was approximately 3 minutes. After jet cooking, the sample was stored in the refrigerator until further use.

### Example 11

### Retention of Fiber in Extruded Food Products

High heat and high shear conditions associated with direct expansion extrusion typically damages and decreases the retention of total dietary fiber (TDF) in extruded food applications. It was discovered, however, that highly hydroxypropyl substituted starches greatly retained their fiber during extrusion processing. In one representative example, a high HP waxy starch with about 9.5% HP-substitution and about 2.4% crosslinking was tested by incorporating the high HP starch with corn meal and comparing the amount of fiber retention to corn meal not containing the highly hydroxypropylated starch following direct expansion extrusion.

A co-rotating intermeshing twin screw extruder (Buhler model BCTL 42) was used to evaluate a highly HP substituted starch in a direct expanded extruded corn puff. A mixture of 15% of the highly HP substituted starch and 85% corn meal, by weight, was compared to corn meal without the high HP starch. The mixtures were fed through the extruder along with an appropriate water feed rate to provide 15%, 18%, and 21% moisture in the dough.

The screw configuration in the extruder was designed to impart high shear (more shear than may be typical of direct expansion extrusion), as shear is detrimental to TDF retention and as such this configuration was chosen to represent especially harsh processing conditions. The extruder screw configuration and extrusion conditions are presented in Tables 2 and 3, respectively.

TABLE 2
Extruder screw configuration for “high shearing” direct expansion.

| | Elem | | | | |
|---|---|---|---|---|---|
| | Length | | | | |
| Elem Part # | (mm) | # elem | type (pitch) | subtotal | total |
| 98-1 | 5 | 3 | polygon disk | 15 | 15 |
| 76-1 | 72 | 1 | FS(72) | 72 | 87 |
| 74-1 | 60 | 5 | FS (60) | 300 | 387 |
| 99-1 | 20 | 1 | Polygon | 20 | 407 |
| | | | block | | |
| 74-1 | 60 | 2 | FS (60) | 120 | 527 |
| 99-1 | 20 | 2 | polygon | 40 | 567 |
| | | | block | | |
| 73-1 | 42 | 4 | FS (42) | 168 | 735 |
| 99-1 | 20 | 0 | polygon | 0 | 735 |
| | | | block | | |
| 73-1 | 42 | 2 | FS(42) | 84 | 819 |
| 99-1 | 20 | 0 | polygon | 0 | 819 |
| | | | block | | |
| 71-1 | 28 | 0 | FS(28) | 0 | 819 |
| 78-1 | 1 | 1 | Spacer | 1 | 820 |
| 72-1 | 14 | 1 | RS (42) | 14 | 834 |
| 78-1 | 1 | 1 | Spacer | 1 | 835 |
| 77-1 | 14 | 1 | FS (42) | 14 | 849 |
| 78-1 | 1 | 0 | Spacer | 0 | 849 |
| 77-1 | 14 | 0 | FS(42) | 0 | 849 |
| 78-1 | 1 | 1 | Spacer | 1 | 850 |
| 72-1 | 14 | 1 | RS (42) | 14 | 864 |
| 78-1 | 1 | 1 | Spacer | 1 | 865 |
| 77-1 | 14 | 1 | FS(42) | 14 | 879 |
| 78-1 | 1 | 1 | Spacer | 1 | 880 |
| 72-1 | 14 | 1 | RS (42) | 14 | 894 |
| 78-1 | 1 | 1 | Spacer | 1 | 895 |
| 71-1 | 28 | 5 | FS(28) | 140 | 1035 |

TABLE 3
Extrusion conditions.

| | | |
|---|---|---|
| Screw speed | 350 rpm | |
| Dough moisture | 15, 18, 21% | |
| Barrel temperature | Zone 1 (feeder) | Off |
| profile | Zone 2 | 60° C. |
| | Zone 3 | 70° C. |
| | Zone 4 | 90° C. |
| | Zone 5 | 120° C. |
| | Zone 6 | 150° C. |
| Extruder dies | 2-3.5 mm die inserts | |
| Cutter | 2 knives at 1200 rpm | |

The retained TDF of direct expanded extruded corn puffs with and without addition of the highly hydroxypropyl substituted starch were analyzed using the AOAC 2009.01 method. Results are shown in Table 4.

TABLE 4

| | | | TDF retention |
|---|---|---|---|
| | | TDF retention | after extrusion |
| | | after extrusion | with 15% HP |
| | | without HP | starch in dry |
| | Dough | starch (% dry | blend (% dry |
| Formula | moisture | basis) | basis) |
| Corn meal with and without | 15% | 1.4% | 12.2/100% |
| highly hydroxypropyl | 18% | 1.7% | 13.4/100% |
| substitued starch | 21% | 3.7% | 13.7/100% |

* AOAC 2009.01 method analyzes soluble and insoluble fiber content.

When the high HP starch was included in the extruded mixture, 100% of its initial TDF was retained.

What is claimed is:

1. A food product comprising a food ingredient and a substituted starch selected from the group consisting of a hydroxypropyl substituted starch, a thinned hydroxypropyl substituted starch, and combinations thereof, wherein the substituted starch comprises at least about 8% hydroxypropyl substitution and wherein the food product comprises at least about 2.5% ethanol soluble fiber.

2. The food product of claim 1 wherein the substituted starch comprises at least about 12.5% hydroxypropyl substitution.

3. The food product of claim 1 wherein the substituted starch comprises at least about 15% hydroxypropyl substitution.

4. The food product of claim 1 wherein the food product comprises at least about 10% ethanol soluble fiber.

5. The food product of claim 1 wherein the food product comprises at least about 20% ethanol soluble fiber.

6. The food product of claim 1 wherein the substituted starch is crosslinked.

7. The food product of claim 1 wherein the food product is an extruded food product.

8. The food product of claim 1 wherein the substituted starch is a thinned hydroxypropyl substituted starch and wherein the food product is a food product traditionally prepared with gelatin.

9. The food product of claim 8 wherein the food product is selected from the group consisting of a marshmallow, a gummy confection, a gelatin dessert, and a pie filling.

10. A method of preparing a food product, said method comprising incorporating a substituted starch selected from the group consisting of a hydroxypropyl substituted starch, a thinned hydroxypropyl substituted starch, and combinations thereof, with at least one other food ingredient to prepare a food product comprising at least about 2.5% ethanol soluble fiber wherein said substituted starch comprises at least about 8% hydroxypropyl substitution.

11. The method of claim 10 wherein the substituted starch comprises at least about 12.5% hydroxypropyl substitution.

12. The method of claim 10 wherein the substituted starch comprises at least about 15% hydroxypropyl substitution.

13. The method of claim 10 wherein the food product comprises at least about 10% ethanol soluble fiber.

14. The method of claim 10 wherein the food product comprises at least about 20% ethanol soluble fiber.

15. The method of claim 10 wherein the substituted starch is crosslinked.

16. The method of claim 10 wherein the food product produced is an extruded food product.

17. The method of claim 10 wherein the extruded food product retains at least about 90% of the ethanol soluble fiber of the pre-processed food formulation from which the extruded food product is produced.

18. The method of claim 10 wherein the substituted starch is a thinned hydroxypropyl substituted starch and wherein the food product is a food product traditionally prepared with gelatin.

19. The method of claim 18 wherein the food product is selected from the group consisting of a marshmallow, a gummy confection, a gelatin dessert, and a pie filling.

20. A food product produced by the method of claim 10.
